(19) United States
(12) Patent Application Publication
(10) Pub. No.: US 2002/0179501 A1
(43) Pub. Date: Dec. 5, 2002

(54) Method of sorting document items into pockets of a document processing system and an apparatus therefor

(75) Inventor: Stephen C. Gawne, Waterloo (CA)

Correspondence Address: Michael Chan, Intellectual Property Section, NCR Corporation, 1700 South Patterson Blvd., Dayton, OH, 45479-0001, US

(73) Assignee: NCR Corporation

(21) Appl. No.: 09/871,934

(22) Filed: Jun. 1, 2001

(51) Int. Cl. G06K 9/00; B07C 5/00

(52) U.S. Cl. 209/534; 382/137

(57) ABSTRACT

A method of processing document items in a document processing system comprises the steps of (a) sorting document items into a predetermined plurality of physical pockets during a sorting pass of a radix sort, (b) partitioning a first plurality of the predetermined plurality of physical pockets to define a first logical pocket during the sorting pass of the radix sort, and (c) sorting certain document items into the first plurality of physical pockets defined in step (b). The method may further comprise the steps of (d) partitioning a second plurality of the predetermined plurality of physical pockets to define a second logical pocket during the sorting pass of the radix sort, and (e) sorting certain other document items into the second plurality of physical pockets defined in step (d). The sorting pass of the radix sort may be the last sorting pass.

### BACKGROUND OF THE INVENTION

The present invention relates to sorting document items, and is particularly directed to a method of sorting document items into pockets of a document processing system, such as an image-based check processing system, and an apparatus therefor.

A typical image-based check processing system includes a check processing transport which has a document track and a number of different hardware devices positioned along the document track for performing specific document processing operations on document items moving downstream along the document track. The check processing system also includes a transport processor which executes a transport application program which is stored in memory to control operation of the hardware devices positioned along the document track and thereby to control operation of the check processing transport.

The check processing transport includes a hopper into which a stack of document items including checks are placed. A document feeder adjacent the hopper selectively feeds or drives each document item from the stack of document items in the hopper to transport the document item from the upstream end to the downstream end along the document track to sorting pockets located at the end of the document track. The pockets are used to receive document items which have been sorted in accordance with the transport application program.

There are a number of ways of sorting document items into the pockets. One way of sorting document items into the pockets is known as a radix sort in which a number of sorting passes is made to sort the document items. For example, if ten physical pockets are available and one thousand document items need to be sorted, then three sorting passes would be needed to complete the radix sort. During each of the first and second sorting passes, all ten physical pockets are used. However, as is known, during the last sorting pass (i.e., the third sorting pass in this example) of the radix sort, only two of the ten physical pockets are used. Since the last sorting pass of the radix sort uses only two of the ten physical pockets, the frequency of track interrupts due to the pockets (i.e., the two of the ten physical pockets) being full is usually much higher during the last sorting pass than the previous sorting passes of the radix sort. It would be desirable to reduce the frequency of track interrupts during the last sorting pass of a radix sort.

### SUMMARY OF THE INVENTION

In accordance with one aspect of the present invention, a method of performing a sorting pass of a radix sort of document items in a document processing system comprises the steps of (a) sorting certain document items into a first group of physical pockets which are the same logical pocket, and (b) sorting other certain document items into a second group of physical pockets which are the same logical pocket. At least one of the first and second groups of physical pockets may comprise a plurality of physical pockets which are the same logical pocket.

In accordance with another aspect of the present invention, a method of processing document items in a document processing system comprises the steps of (a) sorting document items into a predetermined plurality of physical pockets during a sorting pass of a radix sort, (b) partitioning a first plurality of the predetermined plurality of physical pockets to define a first logical pocket during the sorting pass of the radix sort, and (c) sorting certain document items into the first plurality of physical pockets defined in step (b). The method may further comprise the steps of (d) partitioning a second plurality of the predetermined plurality of physical pockets to define a second logical pocket during the sorting pass of the radix sort, and (e) sorting certain other document items into the second plurality of physical pockets defined in step (d). The sorting pass of the radix sort may be the last sorting pass.

In accordance with another aspect of the present invention, a method of performing a sorting pass of a radix sort of document items in a financial document processing system comprises the steps of (a) determining a digit range of the sorting pass of the radix sort, and (b) dividing the digit range of the sorting pass into the total number of physical pockets available for receiving sorted document items to provide a quotient which is representative of a logical pocket map associated with the sorting pass of the radix sort.

In accordance with another aspect of the present invention, an apparatus is provided for performing a sorting pass of a radix sort of document items in a document processing system. The apparatus comprises means for sorting certain document items into a first group of physical pockets which are the same logical pocket, and means for sorting other certain document items into a second group of physical pockets which are the same logical pocket. At least one of the first and second groups of physical pockets may comprise a plurality of physical pockets which are the same logical pocket, or each of the first and second groups of physical pockets may comprise a plurality of physical pockets. The apparatus may further comprise means for sorting other certain document items into a third group of physical pockets which are the same logical pocket. At least one of the first, second, and third groups of physical pockets may comprise a plurality of physical pockets which are the same logical pocket, or each of the first, second, and third groups of physical pockets may comprise a plurality of physical pockets.

In accordance with yet another aspect of the present invention, an apparatus is provided for processing document items in a document processing system. The apparatus comprises means for sorting document items into a predetermined plurality of physical pockets during a sorting pass of a radix sort, means for partitioning a first plurality of the predetermined plurality of physical pockets to define a first logical pocket during the sorting pass of the radix sort, and means for sorting certain document items into the first plurality of physical pockets. The apparatus may further comprise means for partitioning a second plurality of the predetermined plurality of physical pockets to define a second logical pocket during the sorting pass of the radix sort, and means for sorting certain other document items into the second plurality of physical pockets. The sorting pass of the radix sort may be the last sorting pass.

In accordance with still another aspect of the present invention, an apparatus is provided for performing a sorting pass of a radix sort of document items in a financial document processing system. The apparatus comprises means for determining a digit range of the sorting pass of the radix sort, and means for dividing the digit range of the sorting pass into the total number of physical pockets available for receiving sorted document items to provide a quotient which is representative of a logical pocket map associated with the sorting pass of the radix sort.

In accordance with yet another aspect of the present invention, a program storage medium is readable by a computer having a memory. The medium tangibly embodies one or more programs of instructions executable by the computer to perform method steps for performing a sorting pass of a radix sort of document items in a document processing system. The method comprises the steps of (a) sorting document items into a predetermined plurality of physical pockets during a sorting pass of a radix sort, (b) partitioning a first plurality of the predetermined plurality of physical pockets to define a first logical pocket during the sorting pass of the radix sort, and (c) sorting certain document items into the first plurality of physical pockets defined in step (b). The method may further comprise the steps of (d) partitioning a second plurality of the predetermined plurality of physical pockets to define a second logical pocket during the sorting pass of the radix sort, and (e) sorting certain other document items into the second plurality of physical pockets defined in step (d). The sorting pass of the radix sort may be the last sorting pass.

In accordance with still another aspect of the present invention, a program storage medium is readable by a computer having a memory. The medium tangibly embodies one or more programs of instructions executable by the computer to perform method steps for performing a sorting pass of a radix sort of document items in a document processing system. The method comprises the steps of (a) determining a digit range of the sorting pass of the radix sort, and (b) dividing the digit range of the sorting pass into the total number of physical pockets available for receiving sorted document items to provide a quotient which is representative of a logical pocket map associated with the sorting pass of the radix sort.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic block representation of an image-based check processing system embodying the present invention;

FIG. 2 is a schematic block representation of a portion of FIG. 1;

FIG. 3 is a flowchart depicting a process carried out in accordance with the present invention;

FIG. 4 is an abstract representation of an array of data which is stored in a sort directive memory portion of the image-based check processing system of FIG. 1;

FIG. 5 is an abstract representation of groups of items contained in a stack of physical document items just before a first sorting pass of a radix sort;

FIG. 6 is a schematic representation of distribution of the physical document items of FIG. 5 in ten physical sorting pockets just after the first sorting pass of the radix sort;

FIG. 7 is an abstract representation similar to the abstract representation of FIG. 5 and showing groups of items contained in a stack of physical document items just before a second sorting pass of the radix sort; and

FIG. 8 is a schematic representation similar to the schematic representation of FIG. 6 and showing distribution of the physical document items of FIG. 7 in the ten physical sorting pockets just after the second sorting pass of the radix sort.

### DETAILS OF THE INVENTION

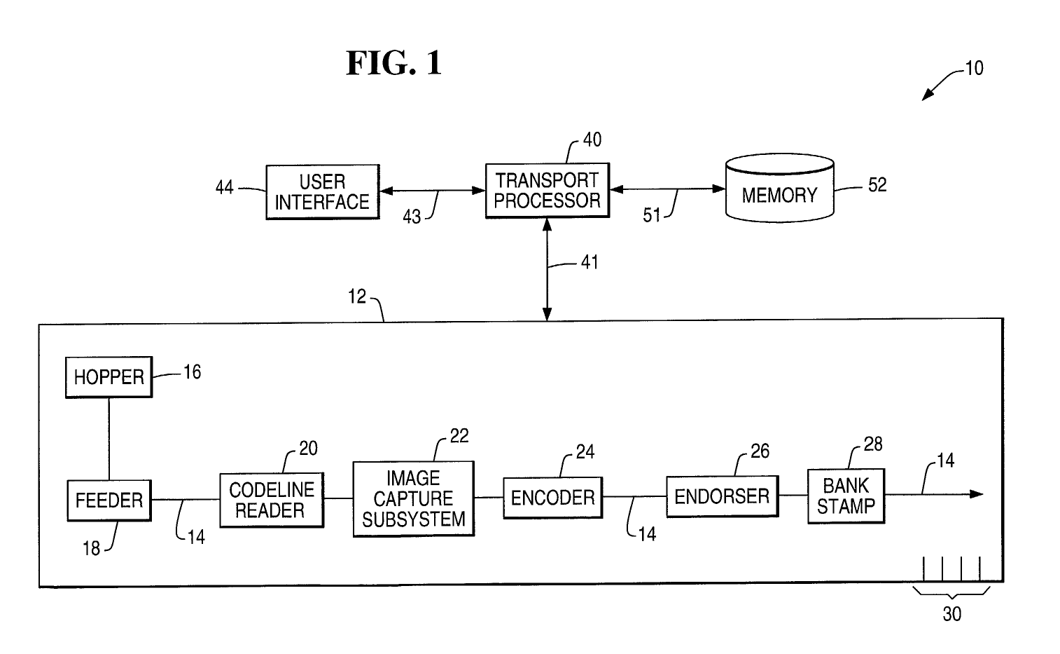

The present invention is directed to sorting document items into physical sorting pockets of a document processing system. The specific construction and use of the document processing system may vary. By way of example, a document processing system in the form of an image-based check processing system 10 is illustrated in FIG. 1. The check processing system 10 may be, for example, a sorting machine or a proof machine wherein financial documents such as checks are processed in a bank.

As shown in FIG. 1, the check processing system 10 includes a check processing transport 12 having a document track which defines a document transport path 14 along which document items, such as checks, can be transported from an upstream end to a downstream end. The transport 12 includes a number of different hardware devices lying along the document transport path 14 for performing specific document processing operations on document items moving along the document transport path 14. The transport 12 includes a hopper 16 into which a stack of document items including checks are placed.

A document feeder 18 adjacent the hopper 16 selectively feeds or drives each document item from the stack of document items in the hopper to transport the document item from the upstream end to the downstream end along the document transport path 14 to a number of sorting pockets 30 located at the end of the document transport path. The actual number of pockets may vary depending upon a number of factors including, for examples, the specific document processing system and the particular application being handled by the document processing system. For purposes of explanation, the sorting pockets 30 include ten physical sorting pockets. The ten physical sorting pockets are referred to individually as 30a, 30b, 30c, 30d, 30e, 30f, 30g, 30h, 30i,and 30j. The ten physical pockets are collectively referred to as “the sorting pockets 30” or simply “the pockets 30”.

The check processing system 10 further includes a codeline reader 20 such as a MICR reader located along the document transport path 14. The MICR reader 20 reads a MICR codeline from each check being processed in a known manner. Alternatively, the codeline reader may be an OCR reader instead of a MICR reader depending upon on the particular application.

The check processing system 10 further includes an image capture subsystem 22 located along the document transport path 14. The image capture subsystem 22 captures an image of each document item for a number of different purposes well known in the financial industry. More specifically, the image capture subsystem 22 includes an imaging camera (not shown) which is controlled to capture images of document items moving along the document transport path 14.

An encoder 24 encodes missing fields on each check. An endorser 26 applies an endorsement in a known manner to each check. A bank stamp 28 stamps each check to identify the bank institution processing the check. The structure and operation of MICR readers, OCR readers, imaging cameras, encoders, endorsers, and bank stamps are well known and, therefore, will not be described.

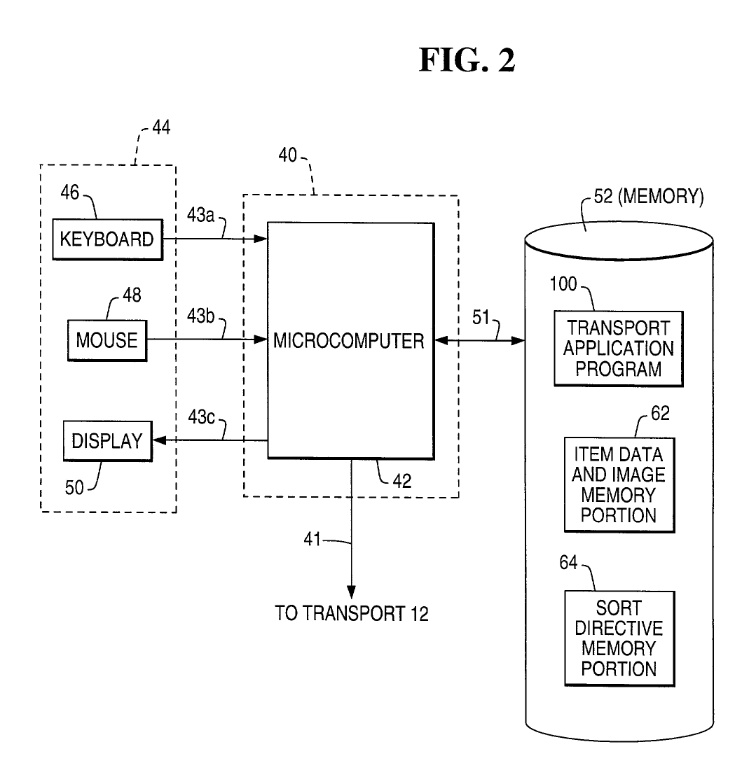

Referring to FIGS. 1 and 2, the check processing system 10 further includes a transport processor 40 and a user interface 44 which communicates via signals on line 43 (FIG. 1) with a microcomputer 42 of the transport processor 40. The user interface 44 includes a keyboard 46, a mouse 48, and a display 50, all of which communicate via signals on lines 43a, 43b, 43c (FIG. 2) with the microcomputer 42. The microcomputer 42 controls operation of the transport 12 via signals on line 41. Suitable microcomputers and memories are readily available in the marketplace. Their structure and operation are well known and, therefore, will not be described.

The check processing system 10 also includes a memory 52 which communicates via signals on line 51 with the microcomputer 42. It is contemplated that the memory 52 could be a single memory unit or a plurality of different memory units. An executable transport application program 100 is stored in the memory 52. The transport application program 100 is associated with a particular type of document processing work. For example, one type of work is sorting of items. Another type of work is remittance processing. Still another type of work is proof of deposit. When the transport application program 100 is executed, the hardware devices lying along the document transport path 14 are controlled to process document items moving downstream along the document transport path 14 in accordance with the particulars of the transport application program, as is known.

The memory 52 includes an item data and image memory portion 62 which stores sequence numbers, MICR codelines, image data, encoder status, endorsement status, and bank stamp status associated with document items which have been processed in accordance with the transport application program 56. The memory 52 also includes a sort directive memory portion 64 which stores data representing all “unique numbers to be sorted” and the “number of occurrences of each unique number to be sorted”. This data which is stored in the sort directive memory portion 64 is well known to those in the art of check processing. Accordingly, the particulars of this data will not be described.

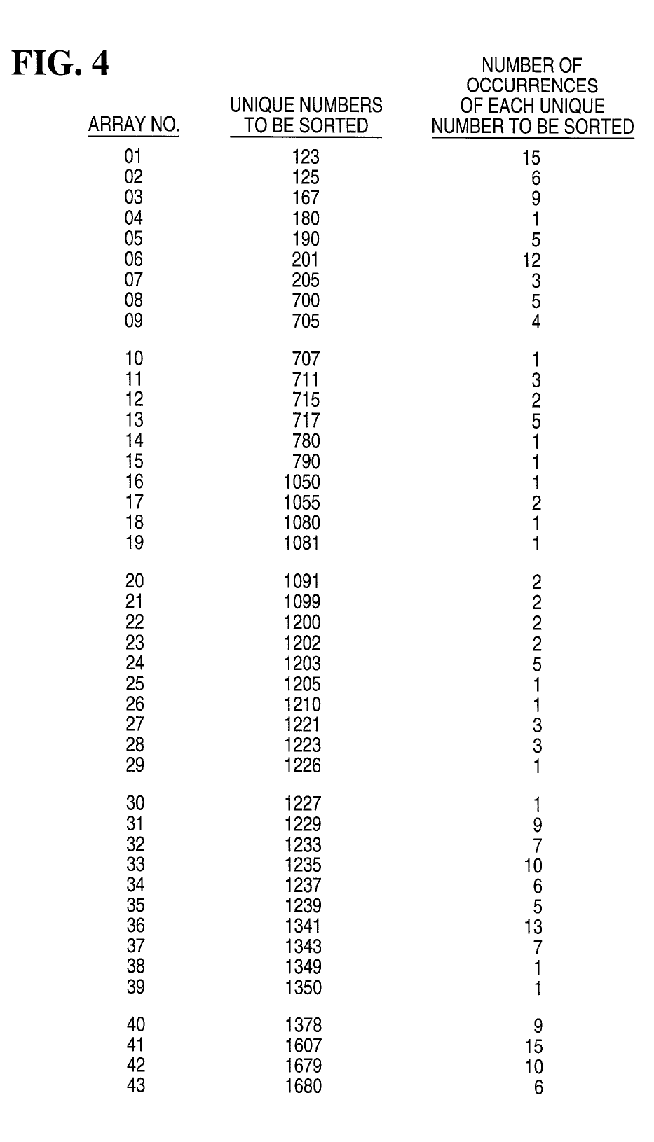

The data stored in the sorting directive memory portion 64 may be represented as arrays. More specifically, each of the “unique numbers to be sorted” and the “number of occurrences of each unique number to be sorted” may be represented as an array as shown in FIG. 4. As shown in FIG. 4, each array has associated therewith a unique number to be sorted and the number of occurrences of that particular number to be sorted. It should be noted that FIG. 4 is an abstract representation of arrays of data stored in the sort directive memory portion 64, and does not represent how physical document items are actually ordered in the stack of physical document items.

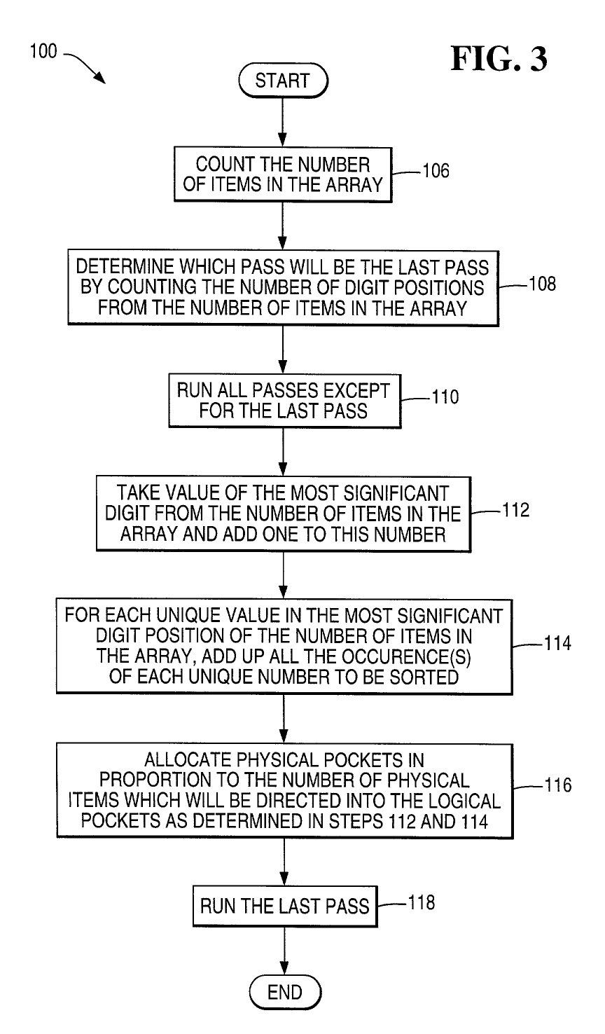

In the present application, the transport application program 100 is directed to the type of work involving sorting of items. More specifically, the type of work involves a radix sort of items. For purposes of describing the present invention, the transport application program 100 will be referred to herein as “the document sorting program 100” or “the program 100”. FIG. 3 is a flowchart which depicts operation of the document sorting program 100, and is described in detail hereinbelow.

The program 100 begins in step 106 in which the actual number of document items in the array of FIG. 4 is counted. As shown in FIG. 4, the number of items in the array is forty-three. Then, in step 108, a determination is made as to which sorting pass will be the last sorting pass. The determination in step 108 is made by taking the number of physical pockets and using this number as a base of a number system, and then counting the number of digit positions from the number of items in the array using this base. Accordingly, in the present example, since there are ten physical pockets and the number of items in the array is forty-three, the number of digit positions is determined in step 108 to be two.

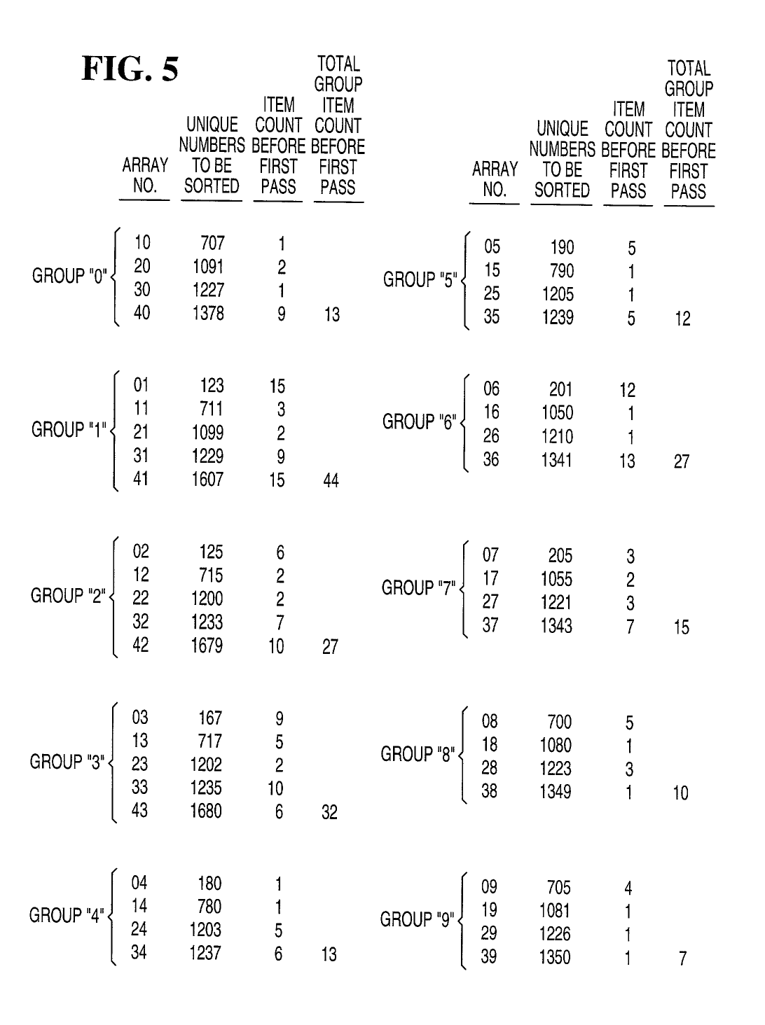

The program 100 then proceeds to step 110 in which all sorting passes except the last sorting pass is run. Since there are a total of two passes as determined in step 108 for the present example case, one sorting pass (i.e., the first sorting pass) is run in step 110. It should be noted that FIG. 5 is an abstract representation of ten different item groups which are contained in a stack of physical document items just before the first sorting pass. As shown in FIG. 5, there are thirteen items associated with Group “0”, forty-four items associated with Group “1”, twenty-seven items associated with Group “2”, thirty-two items associated with Group “3”, thirteen items associated with Group “4”, twelve items associated with Group “5”, twenty-seven items associated with Group “6”, fifteen items associated with Group “7”, ten items associated with Group “8”, and seven items associated with Group “9”.

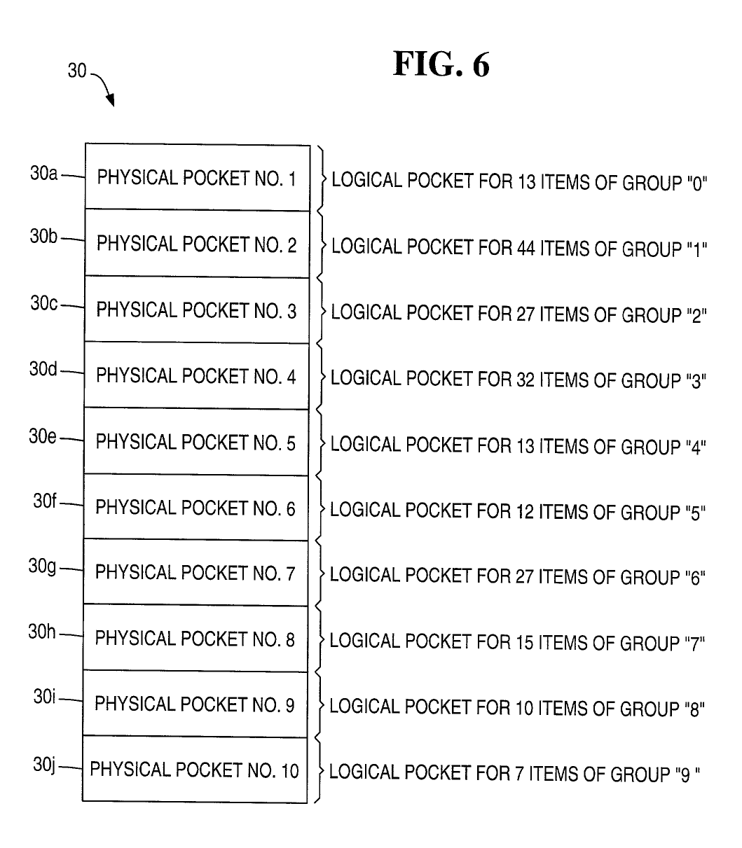

Results after the first sorting pass are shown in FIG. 6. FIG. 6 is a representation of which of the pockets 30 each of the ten different item groups is sorted into after the first sorting pass. As shown in FIG. 6, the Group “0” items are sorted into pocket 30a, the Group “1” items are sorted into pocket 30b, the Group “2” items are sorted into pocket 30c, the Group “3” items are sorted into pocket 30d, the Group “4” items are sorted into pocket 30e, the Group “5” items are sorted into pocket 30f, the Group “6” items are sorted into pocket 30g, the Group “7” items are sorted into pocket 30h, the Group “8” items are sorted into pocket 30i, and the Group “9” items are sorted into pocket 30j. It should be noted that each of the physical pockets 30 shown in FIG. 6 has one corresponding logical pocket associated therewith.

After the first sorting pass in the present example is run, the program 100 proceeds to step 112. In step 112, a value of “one” is added to the value of the most significant digit from the number of items in the array. Since the value of the most significant digit from the number of items in the array is “four”, the result of step 112 is a value of “five”. The resulting value from step 112 is represents the number of logical pockets which will be needed in the last sorting pass (which is the second sorting pass in this example). Accordingly, in the present example, five logical pockets will be needed in the last sorting pass. The program 100 then proceeds to step 114.

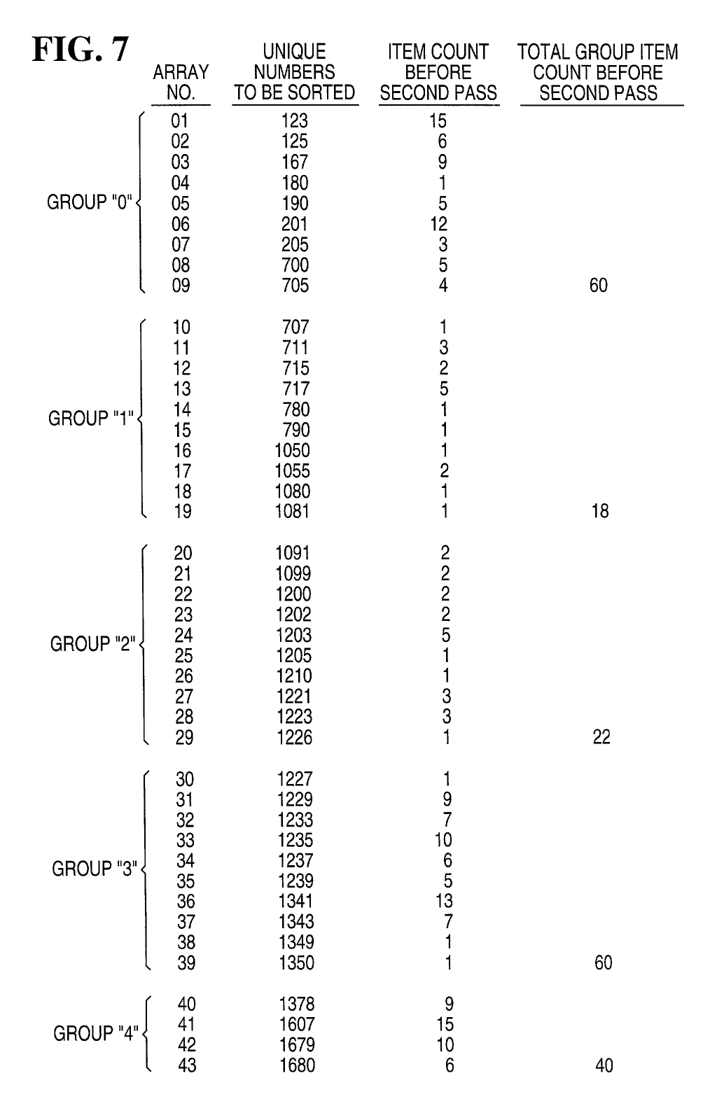

In step 114, for each unique value in the most significant digit position of the number of items in the array, all of the occurrences of each unique number to be sorted are added up. In the present example, there are five unique values in the most significant digit position of the number of items in the array. The unique numbers are “0”, “1”, “2”, “3”, and “4”. It should be noted that FIG. 7 is an abstract representation of five different item groups which are contained in a stack of physical document items just before the last sorting pass. As shown in FIG. 7, there are sixty items associated with Group “0”, eighteen items associated with Group “1”, twenty-two items associated with Group “2”, sixty items associated with Group “3”, and forty items associated with Group “4”.

The program 100 proceeds to step 116 in which the pockets 30 are allocated in proportion to the number of physical document items (as per step 114 ) which will be directed into the logical pockets as determined in step 112. More specifically, for each group of items in the last sorting pass, the number of physical pockets to be associated for each logical pocket is determined using the following formula:

$$\frac{Total \# of Items In Group}{Total \# of All Items} \times Total \# of Physical Pockets$$

It should be noted that whenever the result of the above formula is greater than a value of “one” and includes a fractional part, the result is to be rounded down to the next whole number. For example, if the result of above formula is 2.63, then the result is to be rounded down to a value of “two”. The value of “two” indicates that two physical pockets are to be associated with one respective logical pocket. It should also be noted that whenever the result of the above formula is less than a value of “one”, then the result is to be rounded up to a value of “one”. The value of “one” indicates that one physical pocket is associated with one respective logical pocket. Accordingly, based upon the above formula, there are three physical pockets associated with the logical pocket for the Group “0” items, one physical pocket associated with the logical pocket for the Group “1” items, one physical pocket associated with the logical pocket for the Group “2” items, three physical pockets associated with the logical pocket for the Group “3” items, and two physical pockets associated with the logical pocket for the Group “4” items.

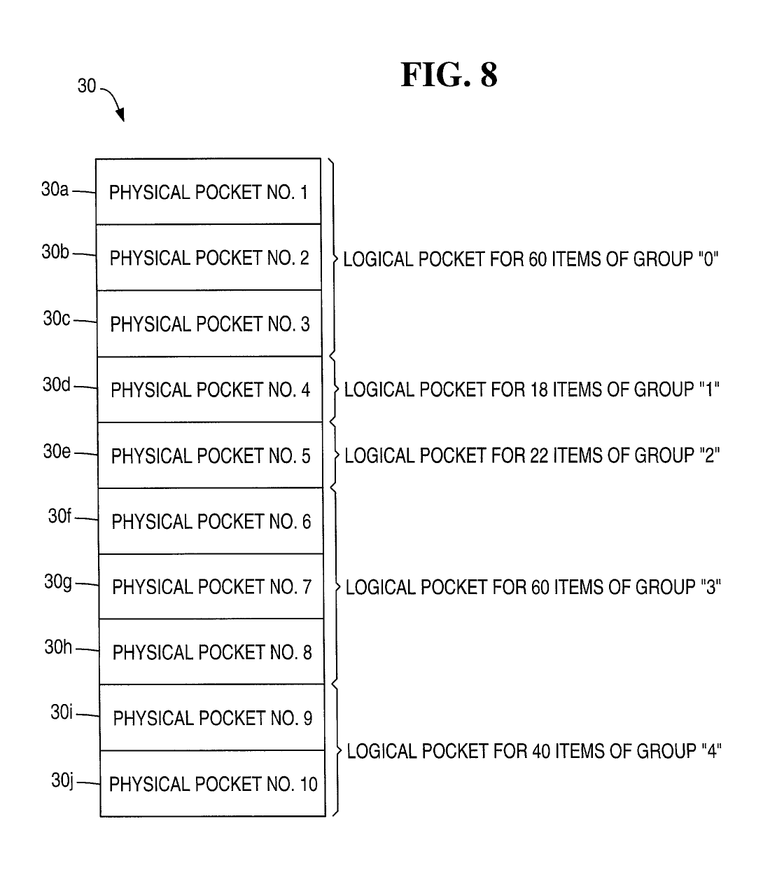

Then in step 118, the last sorting pass is run. FIG. 8 is a representation of which of the pockets 30 each of the five different item groups is sorted into after the last sorting pass (i.e., the second sorting pass). As shown in FIG. 8, the Group “0” items are sorted into pockets 30a, 30b, and 30c, the Group “1” items are sorted into pocket 30d, the Group “2” items are sorted into pocket 30e, the Group “3” items are sorted into pockets 30f, 30g, and 30h, and the Group “4” items are sorted into pockets 30i and 30j. The three pockets 30a, 30b, and 30c are associated with one logical pocket. The pocket 30d is associated with one logical pocket. The pocket 30e is associated with one logical pocket. The three pockets 30f, 30g, and 30h are associated with one logical pocket. The two pockets 30i and 30j are associated with one logical pocket.

It should be apparent that the pockets 30 are mapped and partitioned into a number of logical pockets based upon the results of steps 112 and 114 in FIG. 3. It should also be apparent that the pockets 30 are mapped and partitioned in a manner which reduces (and eliminates in some instances) the need to empty any of the pockets 30 due to a pocket being full during the last sorting pass of the radix sort. The pockets 30 should need to be emptied only once after the last sorting pass has been completed. Also, it should be noted that whenever all physical pockets associated with any one logical pocket are full, the operator will be prompted (such as via the display 50 ) to empty all of the physical pockets associated with that particular logical pocket.

Although the above describes a process for the last sorting pass of the radix sort, it is contemplated that the process may also be applied to a previous sorting pass of the radix sort. Accordingly, the process may be applied to any sorting pass of a radix sort. The process is especially advantageous in a sorting pass of a radix sort when the distribution of items to be sorted is skewed such that certain pockets receive a relatively large number of items and other certain pockets receive a relatively small number of items.

A number of advantages result by providing a method of sorting document items into the pockets 30 of the check processing system 10 in accordance with the present invention. One advantage is that the number of track interrupts along the document transport path 14 due to physical pockets being full is reduced. Accordingly, an operator is able to achieve higher wall clock throughput of document items. This results in higher productivity of operators. Another advantage is that the number of service calls and downtime of the check processing system 10 are reduced due to more even distribution of wear over all of the pockets 30.

It is contemplated that the above-described programs be available on portable storage media, such as a compact disc read only memory (CDROM)). The programs on a CDROM may be installed on different document processing systems to provide these systems with corresponding capabilities as described above. It is also contemplated that the radix sort process described above may be used in other types of document processing systems, such as non-image-based systems, for example.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of performing a sorting pass of a radix sort of document items in a document processing system, the method comprising the steps of:
(a) sorting certain document items into a first group of physical pockets which are the same logical pocket; and
(b) sorting other certain document items into a second group of physical pockets which are the same logical pocket.

2. A method according to claim 1, wherein at least one of the first and second groups of physical pockets comprises a plurality of physical pockets which are the same logical pocket.

3. A method according to claim 2, wherein each of the first and second groups of physical pockets comprise a plurality of physical pockets.

4. A method according to claim 1, further comprising the step of:
(c) sorting other certain document items into a third group of physical pockets which are the same logical pocket.

5. A method according to claim 4, wherein at least one of the first, second, and third groups of physical pockets comprises a plurality of physical pockets which are the same logical pocket.

6. A method according to claim 5, wherein each of the first, second, and third groups of physical pockets comprise a plurality of physical pockets.

7. A method of processing document items in a document processing system, the method comprising the steps of:
(a) sorting document items into a predetermined plurality of physical pockets during a sorting pass of a radix sort;
(b) partitioning a first plurality of the predetermined plurality of physical pockets to define a first logical pocket during the sorting pass of the radix sort; and
(c) sorting certain document items into the first plurality of physical pockets defined in step (b).

8. A method according to claim 7, further comprising the steps of:
(d) partitioning a second plurality of the predetermined plurality of physical pockets to define a second logical pocket during the sorting pass of the radix sort; and
(e) sorting certain other document items into the second plurality of physical pockets defined in step (d).

9. A method according to claim 8, wherein the sorting pass of the radix sort is the last sorting pass.

10. A method of performing a sorting pass of a radix sort of document items in a financial document processing system, the method comprising the steps of:
(a) determining a digit range of the sorting pass of the radix sort; and
(b) dividing the digit range of the sorting pass into the total number of physical pockets available for receiving sorted document items to provide a quotient which is representative of a logical pocket map associated with the sorting pass of the radix sort.

11. An apparatus for performing a sorting pass of a radix sort of document items in a document processing system, the apparatus comprising:
means for sorting certain document items into a first group of physical pockets which are the same logical pocket; and
means for sorting other certain document items into a second group of physical pockets which are the same logical pocket.

12. An apparatus according to claim 11, wherein at least one of the first and second groups of physical pockets comprises a plurality of physical pockets which are the same logical pocket.

13. An apparatus according to claim 11, wherein each of the first and second groups of physical pockets comprise a plurality of physical pockets.

14. An apparatus according to claim 11, further comprising means for sorting other certain document items into a third group of physical pockets which are the same logical pocket.

15. An apparatus according to claim 14, wherein at least one of the first, second, and third groups of physical pockets comprises a plurality of physical pockets which are the same logical pocket.

16. An apparatus according to claim 15, wherein each of the first, second, and third groups of physical pockets comprise a plurality of physical pockets.

17. An apparatus for processing document items in a document processing system, the apparatus comprising:
means for sorting document items into a predetermined plurality of physical pockets during a sorting pass of a radix sort;
means for partitioning a first plurality of the predetermined plurality of physical pockets to define a first logical pocket during the sorting pass of the radix sort; and
means for sorting certain document items into the first plurality of physical pockets.

18. An apparatus according to claim 17, further comprising means for partitioning a second plurality of the predetermined plurality of physical pockets to define a second logical pocket during the sorting pass of the radix sort, and means for sorting certain other document items into the second plurality of physical pockets.

19. An apparatus according to claim 18, wherein the sorting pass of the radix sort is the last sorting pass.

20. An apparatus for performing a sorting pass of a radix sort of document items in a financial document processing system, the apparatus comprising:
means for determining a digit range of the sorting pass of the radix sort; and
means for dividing the digit range of the sorting pass into the total number of physical pockets available for receiving sorted document items to provide a quotient which is representative of a logical pocket map associated with the sorting pass of the radix sort.

21. A program storage medium readable by a computer having a memory, the medium tangibly embodying one or more programs of instructions executable by the computer to perform method steps for performing a sorting pass of a radix sort of document items in a document processing system, the method comprising the steps of:
(a) sorting document items into a predetermined plurality of physical pockets during a sorting pass of a radix sort;
(b) partitioning a first plurality of the predetermined plurality of physical pockets to define a first logical pocket during the sorting pass of the radix sort; and
(c) sorting certain document items into the first plurality of physical pockets defined in step (b).

22. A program storage medium according to claim 21, wherein the method further comprises the steps of:
(d) partitioning a second plurality of the predetermined plurality of physical pockets to define a second logical pocket during the sorting pass of the radix sort; and
(e) sorting certain other document items into the second plurality of physical pockets defined in step (d).

23. A program storage medium according to claim 22, wherein the sorting pass of the radix sort is the last sorting pass.

24. A program storage medium readable by a computer having a memory, the medium tangibly embodying one or more programs of instructions executable by the computer to perform method steps for performing a sorting pass of a radix sort of document items in a document processing system, the method comprising the steps of:
(a) determining a digit range of the sorting pass of the radix sort; and
(b) dividing the digit range of the sorting pass into the total number of physical pockets available for receiving sorted document items to provide a quotient which is representative of a logical pocket map associated with the sorting pass of the radix sort.
